(19) United States
(12) Patent Application Publication
(10) Pub. No.: US 2006/0016019 A1
(43) Pub. Date: Jan. 26, 2006

(54) Method of laundering articles

(75) Inventor: David James Dore, Derbyshire (GB)

Correspondence Address: EGBERT LAW OFFICES, 412 MAIN STREET, 7TH FLOOR, HOUSTON, TX, 77002, US

(73) Assignee: FABIC CARE RESEARCH ASSOCIATION LIMITED, Derbyshire (GB)

(21) Appl. No.: 10/515,973

(22) PCT Filed: Jul. 10, 2003
(86) PCT No.: PCT/GB03/02999

§ 371 Date: Nov. 24, 2004

(30) Foreign Application Priority Data
Jul. 12, 2002 (GB) 0216173.5

(51) Int. Cl. C11D 3/00

(52) U.S. Cl. 8/115.51

(57) ABSTRACT

A method of laundering articles is described wherein water used is heated to no more than 40° C. and wherein in a single washing process there are no more than two wash cycles followed by at least one rinse cycle. In one of the wash cycles at least two laundry preparations are used, a first of the laundry preparations being in powder form and including up to 15% by weight a powdered detergent, and a second of the laundry preparations being in liquid form and including at least one of a degreasing emulsifier and a bleach. In addition, the laundry preparations in total have up to 10% by weight a terpene. As the method uses water temperatures of no more than 40° C., significant savings can be made in the energy that would otherwise be used on heating the washing water and a separate bleaching cycle is not required.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a method of laundering articles, in particular heavily soiled and specialized fabric materials such as whitework, workwear and high visibility garments and articles at temperatures of no more than 40° C.

### BACKGROUND OF THE INVENTION

In commercial laundries, industrial-size washing machines containing up to 100 kg of articles for washing are used which depend on a constant flow of pre-heated water and into which metered quantities of washing powder and adjuncts are pumped by dosing apparatus. Conventionally, in order to wash heavily soiled articles such as table cloths, hospital bedding, workwear and the like, it is necessary to use high-temperature water, mechanical action within the washing machine, and high alkalinity and enzyme detergents. The cost of pre-heating the water to temperatures of 60° C. and greater for use in the washing process makes up a significant proportion of the cost of such a process. Typically the water is heated by injecting steam into it and significant time and energy is taken up producing the steam for this purpose.

Also, as the washing cycle itself is likely to be for time in excess of 20 minutes, steam continues to have to be generated throughout the washing cycle to ensure that the washing liquor is maintained at the correct temperature. Such heavy washing also typically requires at least two and sometimes more rinse cycles to remove the washing preparations from the articles and reduce their alkalinity to acceptable levels.

In addition, articles such as whitework, such as table and bed linen, and white workwear are usually bleached.

However, the maximum temperature at which conventional bleaches can be used within a washing process is 60° C. if damage to the washed articles is to be prevented. As the washing cycle of such articles usually takes place at around 80° C., a separate bleaching cycle must be carried out wherein a cooler water temperature is used. This prolongs the washing process and involves the use of a considerable quantity of water that still requires heating to the appropriate temperature.

There are, however, some forms of specialized fabric materials which cannot be cleaned by such means, in particular high visibility garments and articles typically comprising fabric to which is adhered tiny reflective glass beads. These fabrics cannot be laundered at high temperatures without significant damage occurring to their reflective capacity. As a result, they tend to be pre-washed or soaked in solvents to remove oil and grease stains before being washed at a low temperature no higher than 40° C. This special treatment adds greatly to the cost of their cleaning.

Also, some fabrics, such as polycottons, which comprise a mixture of synthetic and natural fibers are liable to suffer “thermal shock” if they undergo a water extraction process such as spinning or pressing immediately after a high temperature washing cycle. This means than they become creased in such a way that the creases are set into the fabric until they are washed again. To prevent thermal shock, this type of fabric must be cooled in stages from say an 80° C. wash down to a 60° C. wash and then down to a 40° C. wash before they can rinsed and the spun or pressed. All of this takes considerable time and energy to carry out the required number of wash cycles at different temperatures.

The object of the present invention is to provide a method of laundering articles, such as those detailed above, that can be used in commercial laundries with conventional washing machines provided with powder dosing apparatus and liquid additive injectors and that overcomes or substantially mitigates the aforementioned problems.

### BRIEF SUMMARY OF THE INVENTION

According to the present invention there is provided a method of laundering articles using water heated to no more than 40° C. wherein in a single washing process there are no more than two wash cycles followed by at least one rinse cycle and wherein in one of the wash cycles a combination of at least two laundry preparations is used, a first of the laundry preparations being in powder form and containing up to 15% by weight a powdered detergent, and a second of the laundry preparations being in liquid form and comprising at least one of a degreasing emulsifier and a bleach, the laundry preparations in total comprising up to 10% by weight a terpene.

Although terpenes, preferably, for example d-limonene or dipentene or a mixture of d-limonene and dipentene, are known ingredients in washing preparations, they have not before been incorporated in such quantity in a laundry preparation for use in combination with a degreasing emulsifier or a bleach. It was surprisingly found that such a combination gives outstanding cleaning results on all forms of heavily soiled and specialized fabric materials using water temperatures of no more than 40° C. This means that significant savings can be made in the energy that would otherwise be used on heating the washing water. Also, as the water used in the present method is never greater than 40° C., unlike conventional laundering methods, a separate bleaching cycle is not required and the bleach can be used in the main wash cycle. This results in significant savings in water consumption, energy consumption and time over conventional methods.

### DETAILED DESCRIPTION OF THE INVENTION

Generally, laundry preparations in powder form are preferred to those in liquid form in industrial laundries because a smaller volume of preparation needs to be used to provide a desired concentration of washing liquor. Usually, a large volume of liquid detergent is required to produce the same concentration. This is inconvenient as regards storage and use of the preparations. Given this, the reason for the combination of a laundry preparation in powder form with one in liquid form in the present invention is that it is not possible to incorporate significant quantities of the degreasing emulsifiers, which comprise liquids, into the powder preparation without it dissolving to form a slurry.

Hence, the requirement for the combination.

The terpenes, which comprise volatile oily liquids, can either be incorporated into the powder preparation, added to the liquid preparation or be injected separately directly into the washing water. Preferably, however, it has been found it that the best cleaning results occur if the terpenes are mixed into the powder preparation. This is also surprising as it is generally thought that the incorporation of such a quantity in a washing preparation would require the preparation to be in a gel or liquid form with the terpene suspended therein in a micro-emulsion otherwise the terpene would quickly evaporate away. Such liquids or gels preclude the dispensing of such a preparation by a conventional powder dosing apparatus associated with an industrial tunnel washing machine. They are also difficult to dispense using liquid injectors in view of their sticky, viscous nature. However, it was surprisingly found that simply by blending up to 10% by weight of a liquid terpene into a dry laundry washing preparation in powder form that the liquid became dispersed within the powder and was thereby retained so that does not evaporate away significantly quickly.

Preferably therefore, the first laundry preparation in powder form contains up to 15% by weight a powdered detergent in which up to 10% by weight a terpene has been dispersed.

Such a preparation is manufactured by dry blending the powdered ingredients and then by mixing the liquid terpene component into the blend to disperse the liquid into the dry powder ingredients. Preferably, the liquid terpene is sprayed into the blended powdered ingredients, which are then further blended to disperse the liquid.

Preferably, the terpene comprises an equal mixture of d-limonene and dipentene and forms up to 5% by weight of the first laundry preparation.

The other ingredients of the powder preparation preferably comprise up to 70% by weight inorganic salts. For example, the preparation may comprise up to 33% by weight sodium carbonate and up to 40% sodium chloride. The sodium carbonate acts in known manner as a water softener and provides alkalinity when dissolved in the washing water. The sodium chloride is believed to act as a synergistic ionic accelerator which improves the action of the other ingredients. A builder, such as sodium tripolyphosphate, may also be added at up to 25% by weight.

An anti-redeposition agent, such as sodium carboxymethylcellulose may also be added to the preparation.

Other optional ingredients may be added to the preparation to produce particular effects. Such ingredients comprise optical brightening agents, enzymes, bleaches, biocides, flame-retardant compounds, dirt repellents, and perfumes.

It will be appreciated, therefore, that the powder preparation operates differently from conventional laundry powders that usually act on greases and oils by saponification, that is by using a high pH washing liquor in combination with an elevated washing temperature and mechanical action oil and grease soiling is removed by turning it into a soap that is then dissolved in the water.

However, in the method of the present invention the terpenes in the laundry preparations act as solvents to dissolve oil and grease soiling directly, the resulting solution then being dispersed and saponified within the washing liquor with the need for a greatly reduced alkalinity to achieve this result. This is a much more efficient process as it does not require a washing liquor temperature of more than 40° C. and significantly less mechanical action, which saves washing time.

The low temperature used in the method also has the significant advantage that thermal shock of the articles being washed is avoided.

Various basic examples of a powder preparation for use in a method according to the invention will now be listed. In all cases, the preparation was manufactured by dry blending of the powdered ingredients into which dry mix the liquid terpene component was sprayed and mixed in to disperse the liquid into the dry powder ingredients. The proportions of the ingredients set forth in the examples are percentages by weight.

### EXAMPLE 1

| | |
|---|---|
| Nonyl phenol ethoxylate (9 ETO) | 4% |
| D-limonene | 5% |
| Sodium carboxymethyl cellulose | 2% |
| Sodium carbonate | 30% |
| Sodium tripolyphosate | 25% |
| Sodium chloride | 34% |

### EXAMPLE 2

| | |
|---|---|
| Nonyl phenol ethoxylate (9 ETO) | 4% |
| Dipentene | 5% |
| Sodium carboxymethyl cellulose | 2% |
| Sodium carbonate | 30% |
| Sodium tripolyphosate | 25% |
| Sodium chloride | 34% |

### EXAMPLE 3

| | |
|---|---|
| Nonyl phenol ethoxylate (9 ETO) | 4% |
| D-limonene | 2.5% |
| Dipentene | 2.5% |
| Sodium carbonate | 30% |
| Sodium tripolyphosate | 25% |
| Sodium chloride | 34% |
| Sodium carboxymethyl cellulose | 2% |

### EXAMPLE 4

| | |
|---|---|
| Nonyl phenol ethoxylate (9 ETO) | 4% |
| D-limonene | 2.5% |
| Dipentene | 2.5% |
| Sodium carbonate | 29% |
| Sodium tripolyphosate | 24% |
| Sodium chloride | 34% |
| Sodium carboxymethyl cellulose | 2% |
| Nitrilotriacetic acid 3NA | 2% |

The above formulations can all be adjusted slightly to take into account the addition, in small quantities, of the additional ingredients such as optical brighteners, blue speckles, perfumes and other common additives to washing powders, for example by adjusting the proportion of sodium chloride in the composition.

The second laundry preparation in liquid form comprises either a bleach or a degreasing emulsifier. If the preparation comprises bleach, then this can comprise any conventional chlorine based bleaching agent, such as sodium hypochlorite, or hydrogen peroxide, both of which are already used in industrial laundries.

If the second laundry preparation comprises a degreasing emulsifier, then this preferably comprises a nonionic surfactant such as, for example nonyl phenol ethoxylate. Alternatively, the degreasing emulsifier may comprise an alcohol ethoxylate.

In order that the efficiencies of the method proposed herein can be appreciated, reference should be made to the following tables wherein four different laundry processes using a method in accordance with the present invention are described in the tables labeled Table 1A-4A for comparison with a conventional laundry method as described in the tables labeled Table 1B-4B. In both cases, the washing processes used the same type of articles and the same type of conventional industrial washing machine comprising a washing drum, powder dosing apparatus and liquid additive injectors to achieve similar cleaning results. In these tables, the time taken for the washing machine to perform various functions within one washing or rinse cycle of a washing processes is indicated, these functions being defined as follows.

Function Definition

| | |
|---|---|
| Fill | Filling a drum of the machine with water to desired level |
| Heat | Heating the water to a desired temperature, as indicated in the table |
| Wash | Tumbling the drum of the machine to cause a mechanical washing action after |
| | the indicated chemical additions have been added to the water to create an |
| | aqueous washing liquor |
| Drain | Draining the aqueous washing liquor from the drum |
| Rinse | Tumbling the drum of the machine to cause a mechanical rinsing action after |
| | any indicated chemical additions have been added to the water to create an |
| | aqueous rinsing liquor |
| Low Extract | Spinning the drum at a relatively low rpm to extract washing liquor from the |
| | articles themselves |
| High Extract | Spinning the drum at a higher rpm than that used in the Low Extract to extract |
| | all free washing liquor from the articles |

The meanings of other terms used with the tables are as follows.

| | |
|---|---|
| Low Dip | This refers to the level to which drum of the machine is filled with water. If |
| | a ‘Low Dip’ is used, the water level is relatively low so that the actual volume |
| | of water used is lower resulting in a higher concentration of any chemical |
| | additions thereto than with a ‘High Dip’ function and also a greater mechanical |
| | action on the articles when the drum is rotated during washing and rinsing |
| | functions. |
| High Dip | This also refers to the level to which drum of the machine is filled with water. |
| | If a ‘High Dip’ is used, the water level is higher than that in the ‘Low Dip’ level |
| | so that the actual volume of water used is greater resulting in a lower |
| | concentration of any chemical additions thereto than with a ‘Low Dip’ function |
| | and also a lower mechanical action on the articles when the drum is rotated |
| | during washing and rinsing functions. |
| Med Dip | This is an abbreviation for ‘Medium Dip’ and again refers to the level to which |
| | drum of the machine is filled with water. If a ‘Med Dip’ is used, the water level |
| | is higher than that in the ‘Low Dip’ level but greater than that in the ‘High Dip’ |
| | level with concomitant effects on the mechanical action and concentration of |
| | the chemical additions. |
| Chemical | These comprise the laundry preparations that are used in the washing and |
| Additions | rinsing functions. In the Tables 1A-4A relating to the washing processes in |
| | accordance with the present invention, the preparations are as defined herein. |
| | In the Tables 1B-4B relating to conventional washing process, the detergents |
| | used are conventional industrial washing powders, which generally do not |
| | contain any significant terpene content, conventional laundry bleaches, and |
| | conventional laundry degreasing emulsifiers. In all cases, the quantities stated |
| | are per kg of articles to be laundered. |

### Laundry Process 1

### Lightly Soiled Cotton Whites

TABLE 1A
Method in Accordance with Present Invention
Total Wash Process Time - 35 minutes

| Function | Parameters | Time | Chemical Additions |
|---|---|---|---|
| Fill | Low dip | 1 | 1. 10 g/kg powder formulated in |
| | | | accordance with the present method |
| | | | 2. 5 ml/kg Liquid bleach |
| Heat | 40° C. | 2 | |
| Wash | | 8 | |
| Drain | | 1 | |
| Low Extract | | 1 | |
| Fill | High dip | 3 | |
| Rinse | | 2 | |
| Drain | | 1 | |
| Low Extract | | 1 | |
| Fill | High dip | 3 | |
| Rinse | | 2 | |
| Drain | | 1 | |
| Low Extract | | 1 | |
| High Extract | | 8 | |

TABLE 1B
Conventional Method
Total Wash Process Time - 50 minutes

| Function | Parameters | Time | Chemical Additions |
|---|---|---|---|
| Fill | Low dip | 1 | 1. 10 g/kg Conventional detergent |
| Heat | 80° C. | 5 | |
| Wash | | 8 | |
| Drain | | 1 | |
| Fill | Med dip | 2 | 1. 5 ml/kg Liquid bleach |
| Heat | 60° C. | 3 | |
| Wash | | 6 | |
| Drain | | 1 | |
| Low Extract | | 1 | |
| Fill | High dip | 3 | |
| Rinse | | 2 | |
| Drain | | 1 | |
| Low Extract | | 1 | |
| Fill | High dip | 3 | |
| Rinse | | 2 | |
| Drain | | 1 | |
| Low Extract | | 1 | |
| High Extract | | 8 | |

### Laundry Process 2

### Heavily Soiled Cotton Whites

TABLE 2A
Method in Accordance with Present Invention
Total Wash Process Time - 45 minutes

| Function | Parameters | Time | Chemical Additions |
|---|---|---|---|
| Fill | Low dip | 1 | 1. 10 g/kg powder formulated in |
| | | | accordance with the present method |
| | | | 2. 5 ml/kg Liquid bleach |
| Heat | 40° C. | 2 | |
| Wash | | 4 | |
| Drain | | 1 | |
| Fill | Low dip | 1 | 1. 5 g/kg powder formulated in |
| | | | accordance with the present method |
| | | | 2. 5 ml/kg Liquid bleach |
| | | | 3. 5 ml/kg Liquid degreasing |
| | | | emulsifier |
| Heat | 40° C. | 2 | |
| Wash | | 10 | |
| Drain | | 1 | |
| Low Extract | | 1 | |
| Fill | High dip | 3 | |
| Rinse | | 2 | |
| Drain | | 1 | |
| Low Extract | | 1 | |
| Fill | High dip | 3 | |
| Rinse | | 2 | |
| Drain | | 1 | |
| Low Extract | | 1 | |
| High Extract | | 8 | |

TABLE 2B
Conventional Method
Total Wash Process Time - 63 minutes

| Function | Parameters | Time | Chemical Additions |
|---|---|---|---|
| Fill | Low dip | 1 | 1. 5 g/kg Conventional detergent |
| | | | 2. 5 ml/kg Bleach |
| Heat | 40° C. | 2 | |
| Wash | | 5 | |
| Drain | | 1 | |
| Fill | Low dip | 1 | 1. 10 g/kg Conventional detergent |
| | | | 2. 5 ml/kg Degreasing emulsifier |
| Heat | 80° C. | 5 | |
| Wash | | 12 | |
| Drain | | 1 | |
| Fill | Med dip | 2 | 1. 5 ml/kg Bleach |
| Heat | 60° C. | 3 | |
| Wash | | 6 | |
| Drain | | 1 | |
| Low Extract | | 1 | |
| Fill | High dip | 3 | |
| Rinse | | 2 | |
| Drain | | 1 | |
| Low Extract | | 1 | |
| Fill | High dip | 3 | |
| Rinse | | 2 | |
| Drain | | 1 | |
| Low Extract | | 1 | |
| High Extract | | 8 | |

### Laundry Process 3

### Coloured Polycotton Overalls

TABLE 3A
Method in Accordance with Present Invention
Total Wash Process Time - 40

| Function | Parameters | Time | Chemical Additions |
|---|---|---|---|
| Fill | Low dip | 1 | 1. 20 g/kg powder formulated in |
| | | | accordance with the present method |
| | | | 2. 8 ml/kg Degreasing emulsifier |
| Heat | 40° C. | 2 | |
| Wash | | 12 | |
| Drain | | 1 | |
| Fill | Low dip | 1 | |
| Heat | 40° C. | 2 | |
| Wash | | 4 | |
| Drain | | 1 | |
| Fill | High dip | 3 | |
| Rinse | | 2 | |
| Drain | | 1 | |
| Fill | High dip | 3 | |
| Rinse | | 2 | |
| Drain | | 1 | |
| Low Extract | | 4 | |

TABLE 3B
Conventional Method
Total Wash Process Time - 56 minutes

| Function | Parameters | Time | Chemical Additions |
|---|---|---|---|
| Fill | Low dip | 1 | 1. 20 g/kg Conventional Detergent |
| | | | 2. 8 ml/kg Degreasing emulsifier |
| Heat | 80° C. | 5 | |
| Wash | | 18 | |
| Drain | | 1 | |
| Fill | Low dip | 1 | |
| Heat | 60° C. | 3 | |
| Wash | | 2 | |
| Drain | | 1 | |
| Fill | Low dip | 1 | 1. 5 g/kg Conventional Detergent |
| Heat | 40° C. | 2 | |
| Wash | | 4 | |
| Drain | | 1 | |
| Fill | High dip | 3 | |
| Rinse | | 2 | |
| Drain | | 1 | |
| Fill | High dip | 3 | |
| Rinse | | 2 | |
| Drain | | 1 | |
| Low Extract | | 4 | |

### Laundry Process 4

### White Polycotton Overalls

TABLE 4A
Method in Accordance with Present Invention
Total Wash Process Time - 40

| Function | Parameters | Time | Chemical Additions |
|---|---|---|---|
| Fill | Low dip | 1 | 1. 12 g/kg powder formulated in |
| | | | accordance with the present method |
| | | | 2. 5 ml/kg Bleach |
| Heat | 40° C. | 2 | |
| Wash | | 4 | |
| Drain | | 1 | |
| Fill | Low dip | 1 | 1. 6 g/kg powder formulated in |
| | | | accordance with the present method |
| | | | 2. 8 ml/kg Degreasing emulsifier |
| | | | 3. 5 ml/kg Bleach |
| Heat | 40° C. | 2 | |
| Wash | | 12 | |
| Drain | | 1 | |
| Fill | High dip | 3 | |
| Rinse | | 2 | |
| Drain | | 1 | |
| Fill | High dip | 3 | |
| Rinse | | 2 | |
| Drain | | 1 | |
| Low Extract | | 4 | |

TABLE 4B
Conventional Method
Total Wash Process Time - 60 minutes

| Function | Parameters | Time | Chemical Additions |
|---|---|---|---|
| Fill | Low dip | 1 | 1. 6 g/kg Conventional Detergent |
| | | | 2. 5 ml/kg Bleach |
| Heat | 40° C. | 2 | |
| Wash | | 4 | |
| Drain | | 1 | |
| Fill | Low dip | 1 | 1. 12 g/kg Conventional Detergent |
| | | | 2. 8 ml/kg Degreasing emulsifier |
| Heat | 80° C. | 5 | |
| Wash | | 12 | |
| Drain | | 1 | |
| Fill | Low dip | 1 | 1. 5 ml/kg Bleach |
| Heat | 60° C. | 3 | |
| Wash | | 6 | |
| Drain | | 1 | |
| Fill | Low dip | 1 | |
| Heat | 40° C. | 2 | |
| Wash | | 2 | |
| Drain | | 1 | |
| Fill | High dip | 3 | |
| Rinse | | 2 | |
| Drain | | 1 | |
| Fill | High dip | 3 | |
| Rinse | | 2 | |
| Drain | | 1 | |
| Low Extract | | 4 | |

The method according to the invention is particularly effective in the washing of heavily soiled materials, in particular whitework and workwear at a temperature which is considerably lower than those conventionally used for such articles. In all of the examples, a maximum of two wash cycles is carried out so that at least one complete wash cycle is omitted as compared to conventional methods. In some cases, for example in Process 4, two whole wash cycles are omitted. It will be appreciated that this is a considerable advantage to commercial laundries in particular because it means that they can achieve the same cleaning efficiency in a much shorter time and without having to heat the large quantities of water required for at least one wash cycle. The cost is therefore considerably reduced. Also, although not featured in the examples above, specialized fabrics materials, such as the relatively delicate high visibility garments already mentioned can be efficiently cleaned without the need to use a high temperature and without having to carry out any pre-wash treatments such as soaking or dipping.

In addition, using the formulations of laundry preparations indicated above also has the added advantage that at the final rinse stage of the washing process, the rinsing water is substantially pH neutral, i.e. pH 7, unlike many conventional laundry powders which tend to be still alkaline at this stage, typically between pH 8 and pH 9. This makes the method in accordance with the present invention ecologically friendly. A maximum of two rinse cycles is only every required and for these unheated water can be used.

Also, if the articles being washed comprise whitework such as bed lines or tableware, then they are often starched and calendered after washing. If the final rinsing liquor is alkaline, then the calendering process can cause sodium matabisulphide sales to be formed in the fabric, leaving brown stains. This is called galling within the laundry industry. It will, be appreciated that in view of the comparative neutrality of the final rinsing liquor in the method according to the present invention that galling is much less likely to occur.

The above formulations are also suitable for use in hard water areas without the need to use water softening preparations and additional salt. They also have biocidal tendencies, which is advantageous generally.

The savings in time in the washing process of the present invention can cause unexpected problems in industrial laundries because the washed articles tend to overload the drying facilities. As an additional, optional feature of the method according to the invention, therefore, preferably in the final rinse cycle of the washing process the articles are rinsed at a low dip in an aqueous solution of a cationic surfactant, typically at 0.6% w/w concentration. It has been found that such a solution tends to increase the run-off of water from the fabric of the articles during the final water extraction by up to 40%. As a result the articles are drier when they leave the washing machine so that they require a shorter drying time.

Preferably, the cationic surfactant comprises a quaternary ammonium compound, for example a benzyl quaternary of ethoxylated monoalkyl amine.

Such a surfactant also has the added advantage that it also forms a sacrificial, mono-molecular film over the surface of the article that conditions the fabric and also tends to repel dirt to reduce resoiling of the article.

Preferably also, the cationic surfactant is used in combination with an alcohol, for example isopropyl alcohol, preferably in a proportion of 3:1 by weight.

The alcohol in combination with the surfactant also provides an unexpected advantage in that it significantly reduces the drying time of the articles which have been rinsed in it. Hence, not only is the quantity of liquid left in the articles after extraction at the end of a washing process significantly reduced but the subsequent drying time of the articles is also lower than would otherwise be expected.

Taking into account all of the aforementioned advantages, it is possible to formulate a standard washing method, as detailed below, that can be used for the majority of articles to be laundered, including heavily blood-stained overalls and bedding, or oil/grease stained overalls.

TABLE 5A
‘Standard’ Method in Accordance with Present Invention
Total Wash Process Time - 29.5 minutes

| Function | Parameters | Time | Chemical Additions |
|---|---|---|---|
| Fill | Low dip | 1 | 1. 15 g/kg powder formulated in |
| | | | accordance with the present method |
| | | | 2. 7 ml/kg Degreasing emulsifier |
| | | | 3. 5 ml/kg Liquid bleach (Optional) |
| Heat | 40° C. | 1 | |
| Wash | | 12 | |
| Drain | | 0.5 | |
| Low Extract | | 1 | |
| Fill | High dip | 3 | |
| Rinse | | 2 | |
| Drain | | 1 | |
| Fill | Low dip | 1 | 1. 0.6% w/w Cationic surfactant with |
| | | | alcohol |
| Rinse | | 2 | |
| Drain | | 1 | |
| Low Extract | | 1 | |
| High Extract | | 3 | |

This method can be adjusted slightly dependent on the nature of the articles being washed, for example by adding bleach or not, but otherwise can stay the same. In some cases, it may be appropriate for the liquid bleach to be added part of the way through the single wash cycle. For example, after 7 minutes of the 12 minute wash, rather than initially.

The method can also be modified by combining both rinse cycles into a single cycle which starts out as a conventional cold rinse at a high dip but which after a predetermined period of time, say 2 minutes, instead of draining all of the rinsing liquor from the machine and starting a second rinse cycle, simply removes the liquor down to the low dip level, adds the cationic surfactant and then conducts a second rinse and the rest of a final rinsing cycle.

If a benefit comparison is carried out by comparing the above washing method for 90 kg dry weight of polycotton workwear with a conventional washing method, such as detailed in Table 3B above for the same quantity and type of workwear using the same industrial washing machine, then the savings in water consumption, hot water consumption, heat energy and time are as follows.

1. Water Savings

| | Present Method | Conventional Method | Saving (%) |
|---|---|---|---|
| Water input | 1278 liters | 1638 liters | 22% |

As water is charged by cost to buy in and to dispose of as waste water, then the 22% saving is doubled with the present method.

2. Hot Water Savings

| | Present Method | Conventional Method | Saving (%) |
|---|---|---|---|
| Hot Water | 248 liters | 608 liters | 59% |

This is calculated using two washes at 80° C. and 60° C. followed by a 40° C. rinse in the conventional method and a single 40° C. wash as indicated in Table 5A in the present method.

3. Heat Energy Savings

| | Present Method | Conventional Method | Saving (%) |
|---|---|---|---|
| Kg of Steam | 9.3 Kg | 45.5 Kg | 80% |
| required | | | |

Using conventional laundry equipment, it costs approximately E10 to produce 1000 Kg of steam.

4. Time Savings

| | Present Method | Conventional Method | Saving (%) |
|---|---|---|---|
| Wash Process | 29.5 minutes | 46.5 minutes | 37% |
| Time taken | | | |
| Total number Of | 13 | 19 (cf. Table 3B) | |
| Machine | | | |
| Operations | | | |

This is again calculated using two washes at 80° C. and 60° C. followed by a 40° C. rinse in the conventional method and a wash method as indicated in Table 5A in the present method.

It will be appreciated, therefore, that the method in accordance with the present invention provides substantial savings to the benefit both of the industrial laundry, the consumer and the environment. The benefits of the method can be summarized as follows.
Can be used with any conventional industrial washing machine
Provides substantial savings on water consumption, steam consumption, and wash dips
The number of separate washing cycles are reduced increasing laundry throughput on a daily basis
The method is suitable for use in hard water areas without the need for salt and water softeners
All types and classifications of laundry can be washed at a maximum of 40° C., including heavy, blood-stained whitework
The savings include less wear and tear on boilers and machinery as the demand for steam is reduced by at least half
The formulations detailed above for use in the method are very low in alkali and the low temperature wash avoids chemical damage occurring to fabrics caused by alkali crystallization within the weave of linen at high temperature (galling)
The total number of washing cycles is reduced over conventional methods
Thermal shock is avoided

1. A method of laundering articles comprising:
using water heated to no more than 40° C. in a single washing process of no more than two wash cycles; and
rinsing in at least one rinse cycle,
wherein in one of the wash cycles a washing mix comprised of at least two laundry preparations is used, a first of the laundry preparations being in powder form and comprising up to 15% by weight a powdered detergent, and a second of the laundry preparations being in liquid form and comprising at least one of a degreasing emulsifier and a bleach, the laundry preparations in total comprising up to 10% by weight a terpene.

2. A method as claimed in claim 1, wherein the rinsing is comprised of no more than two rinse cycles.

3. A method as claimed in claim 1, wherein a final rinse cycle comprises rising articles in an aqueous solution of a cationic surfactant.

4. A method as claimed in claim 3, wherein a single rinse cycle commences with a cold water rinse at a high dip; and wherein after a predetermined period of time rinsing liquor is drained down to a low dip level prior to the addition of the cationic surfactant thereto.

5. A method as claimed in claim 3, wherein the cationic surfactant comprises a quaternary ammonium compound.

6. A method as claimed in claim 3, wherein the cationic surfactant comprises a benzyl quaternary of ethoxylated monoalkyl amine.

7. A method as claimed in claim 3, wherein the final rinse cycle comprises rinsing the articles in an aqueous solution comprised of a cationic surfactant and an alcohol.

8. A method as claimed in claim 7, wherein relative proportion of the cationic surfactant to the alcohol is 3:1.

9. A method as claimed in claim 8, wherein the cationic surfactant and alcohol are added to a final rinse solution to produce a 0.6% w/w concentration.

10. A method as claimed in claim 7, wherein the alcohol comprises an isopropyl alcohol.

11. A method as claimed in claim 1, wherein the terpene is comprised of a d-limonene or dipentene or a mixture of d-limonene and dipentene.

12. A method as claimed in claim 11, wherein the terpene comprises an equal mixture of d-limonene and dipentene.

13. A method as claimed in claim 1, wherein the first laundry preparation comprises the terpene at 5% by weight.

14. A method as claimed in claim 1, wherein the liquid degreasing emulsifier is comprised of a nonionic surfactant.

15. A method as claimed in claim 14, wherein the nonionic surfactant is comprised of a nonyl phenol ethoxylate or an alcohol ethoxylate.

16. A method as claimed in claim 1, wherein the first laundry preparation comprises up to 70% by weight inorganic salts.

17. A method as claimed claim 1, wherein the first laundry preparation comprises up to 33% by weight sodium carbonate.

18. A method as claimed in claim 1, wherein the first laundry preparation comprises up to 40% by weight sodium chloride.

19. A method as claimed in claim 1, wherein the first laundry preparation is as described.

20. A method of laundering articles as claimed in claim 1 and as described herein.

21. A method as claimed in claim 20, wherein a final rinse cycle comprises rinsing the articles in an aqueous solution of a cationic surfactant.
